(19) United States
(12) Patent Application Publication
(10) Pub. No.: US 2007/0184365 A1
(43) Pub. Date: Aug. 9, 2007

(54) Patterning method and manufacturing method for a display device

(75) Inventor: Bo-sung Kim, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/703,864

(22) Filed: Feb. 7, 2007

(30) Foreign Application Priority Data
Feb. 8, 2006 (KR) 10-2006-0012114

(51) Int. Cl. G02B 5/20; H01J 9/227; G03C 11/12

(52) U.S. Cl. 430/7; 430/321; 430/258

(57) ABSTRACT

A patterning method includes coating a photosensitive surface active agent on a base film, forming an organic layer on the surface active agent, decreasing adhesion between the surface active agent and the organic layer by exposing light through a mask having a predetermined opening on the organic layer, adhering the base film to an insulating substrate with the organic layer facing the insulating substrate, and transferring the organic layer which is corresponded to the exposed surface active agent to the insulating substrate by separating the base film from the insulating substrate. The method provides a simplified patterning process, and a manufacturing method of a display device using the same.

### CROSS-REFERENCE TO RELATED APPLICATIONS

This application claims the benefit of Korean Patent Application No. 2006-0012114, filed on Feb. 8, 2006, in the Korean Intellectual Property Office, the disclosure of which is incorporated herein by reference.

### BACKGROUND OF THE INVENTION

1. Field of the Invention

The present invention relates to a patterning method and a manufacturing method for a display device. More particularly, the present invention relates to a patterning method and a manufacturing method for a display device in which a pattern of an organic layer is formed on an insulating substrate.

2. Description of the Related Art

Flat display panels have become popular because they are light and have a small footprint. The flat display device comprises a liquid crystal display (LCD) and an organic light emitting diode (OLED). Such display devices comprise an organic layer which is formed as a predetermined pattern.

For example, the LCD comprises a thin film transistor substrate, a color filter substrate, and a liquid crystal layer interposed between the two substrates. The thin film transistor substrate may comprise an organic semiconductor layer having an organic material. The color filter substrate may comprise a black matrix and a color filter layer comprising an organic material.

The organic semiconductor layer is formed as a predetermined pattern by an evaporation or inkjet method. The black matrix and the color filter layer are formed as a predetermined pattern by uniformly coating a photosensitive organic film on an insulating substrate, followed by exposure and development processes.

However, such organic layer-forming methods require additional equipment or processes, thereby causing complex processes.

### SUMMARY OF THE INVENTION

Accordingly, it is an aspect of the present invention to provide a patterning method having a simple manufacturing process, and a manufacturing method for a display device.

Additional aspects and advantages of the present invention are set forth in the description.

The foregoing and other aspects of the present invention can be achieved by providing a patterning method, comprising: coating a photosensitive surface active agent on a base film; forming an organic layer on the surface active agent; decreasing adhesiveness between the surface active agent and the organic layer by exposing the surface active agent to light through a mask having a predetermined opening; adhering the base film to an insulating substrate with the organic layer facing the insulating substrate; and transferring the organic layer corresponding to the exposed surface active agent to the insulating substrate by separating the base film from the insulating substrate.

According to one embodiment of the present invention, the method further comprises, after adhering the base film to the insulating substrate, increasing adhesion between the organic layer and the insulating substrate by heating.

According to an embodiment of the present invention, the surface active agent and the organic layer are hydrophobic, and the surface active agent is changed to hydrophilic by being exposed to light to decrease the adhesion between the surface active agent and the organic layer.

According to an embodiment of the present invention, the opening corresponds to an area transferring to the insulating substrate of the organic layer.

According to an embodiment of the present invention, the surface active agent comprises a tertiary-butoxy carbonyl group (tBOC group).

According to an embodiment of the present invention, the surface active agent further comprises a photo acid generator (PAG).

According to an embodiment of the present invention, the organic layer comprises an organic semiconductor layer, and the insulating substrate comprises a source electrode and a drain electrode, which are separately spaced from each other and define a channel area, where the opening corresponds to the channel area.

According to an embodiment of the present invention, the adhering of the base film to the insulating substrate comprises adhering the base film to the insulating substrate so that the organic layer corresponding to the exposed surface active agent corresponds to the channel area.

According to an embodiment of the present invention, the organic layer is transferred to the channel area to contact with a part of the source electrode and the drain electrode.

According to an embodiment of the present invention, the method further comprises a pixel electrode which partially contacts with the drain electrode, and wherein the source electrode, the drain electrode and the pixel electrode are formed by the same mask.

According to an embodiment of the present invention, the source electrode, the drain electrode and the pixel electrode comprise one of indium tin oxide (ITO) and indium zinc oxide (IZO).

According to an embodiment of the present invention, a black matrix is provided on the insulating substrate, and the organic layer comprises a color filter layer, and the organic layer is transferred to an intermediate area of the black matrix.

According to an embodiment of the present invention, the opening corresponds to the intermediate area of the black matrix.

According to an embodiment of the present invention, the organic layer comprises a black matrix.

According to an embodiment of the present invention, a thin film transistor and a pixel electrode which is connected with the thin film transistor are provided on the insulating substrate, and the organic layer comprises an organic light emitting layer, and the organic layer is transferred to the pixel electrode.

According to an embodiment of the present invention, the opening corresponds to the pixel electrode.

### BRIEF DESCRIPTION OF THE DRAWINGS

The above and other aspects and advantages of the present invention will become apparent and more readily appreciated from the following description of the embodiments, taken in conjunction with the accompanying drawings of which:

FIGS. 1A through 1G illustrate a patterning method according to the present invention, sequentially;

FIGS. 2A through 2C illustrate a reaction when light is emitted to a surface active agent;

FIG. 3A illustrates a thin film transistor substrate according to the present invention;

FIG. 3B is a sectional view of the thin film transistor substrate taken along line IIIb-IIIb′ in FIG. 3A;

FIGS. 4A through 4F illustrate a manufacturing method of the thin film transistor substrate according to the present invention;

FIG. 5 illustrates a manufacturing method of a color filter substrate according to the present invention; and

FIG. 6 illustrates a manufacturing method of an organic light emitting diode (OLED) according to the present invention.

### DETAILED DESCRIPTION OF EMBODIMENTS

Hereinafter, embodiments of the present invention are described with reference to accompanying drawings, wherein like numerals refer to like elements and repetitive descriptions will be avoided as necessary.

Hereinafter, when a first layer or film is described to be “on” or “above” a second layer or film, it is understood that an intervening layer or film may be, but not necessarily, interposed. When a first layer or film is described to be “directly on” a second layer or film, it is understood that the two layers or films are in contact with each other.

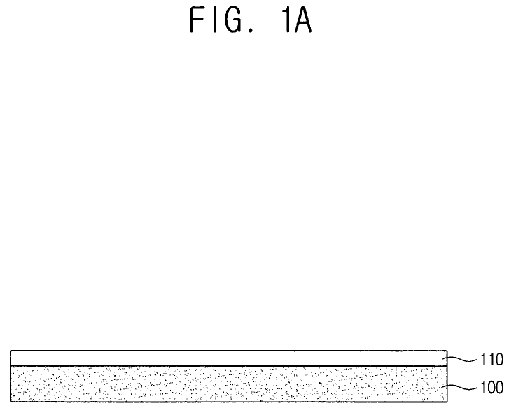

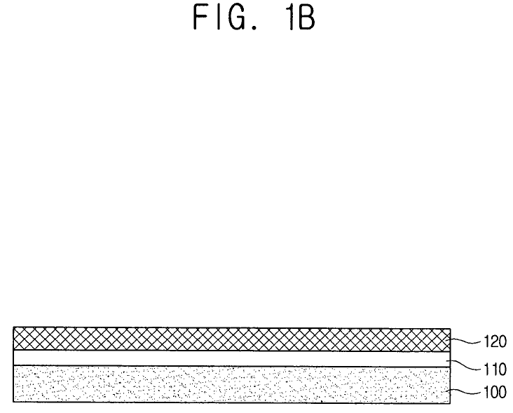

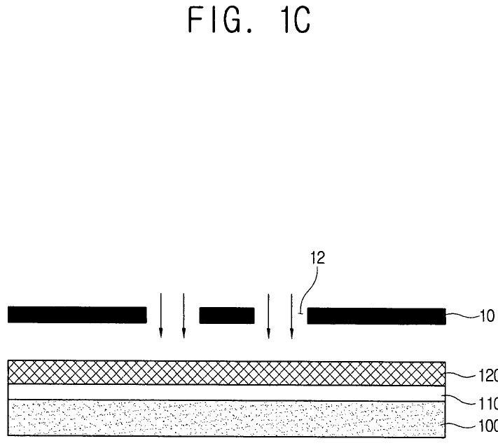

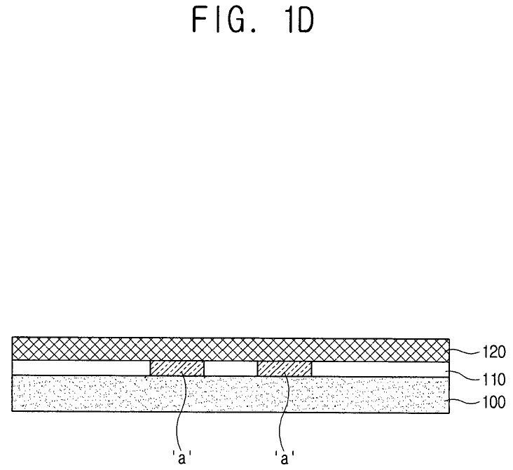

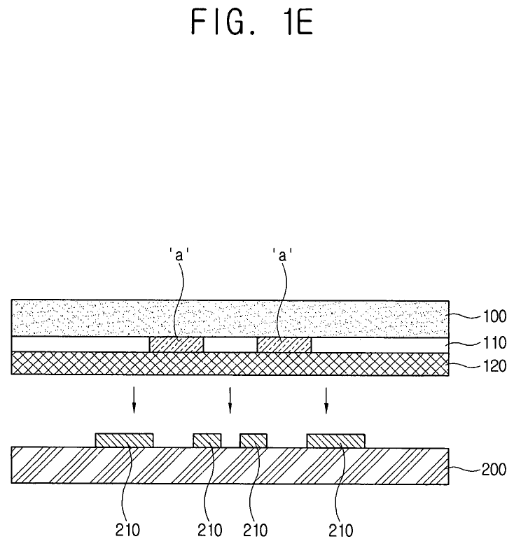

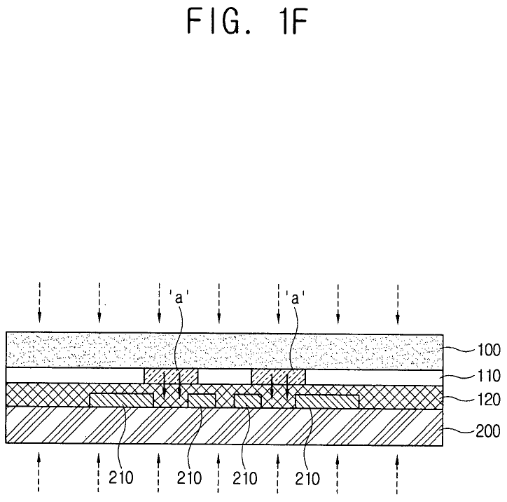

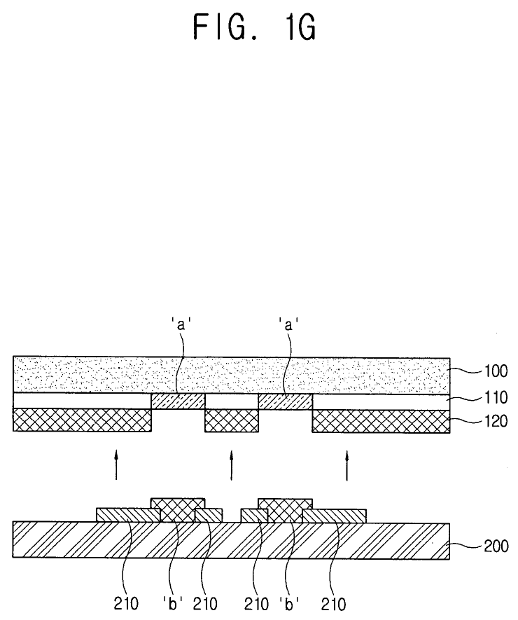

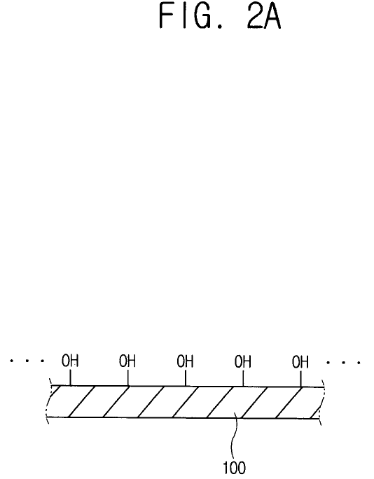

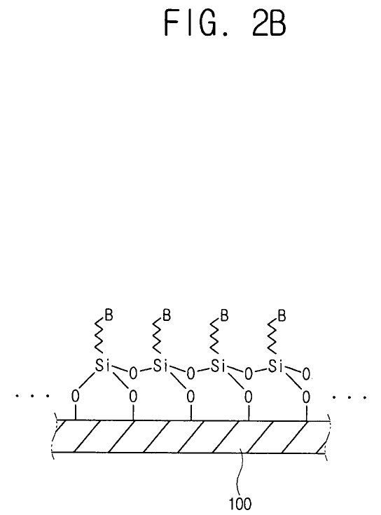

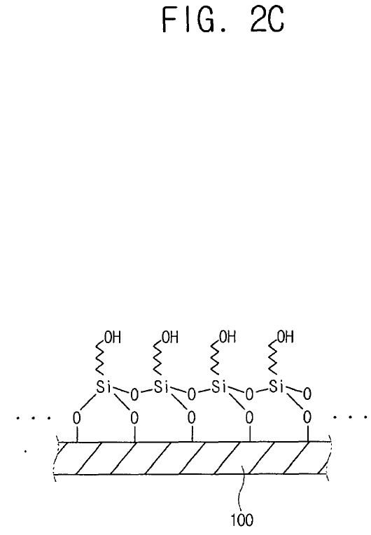

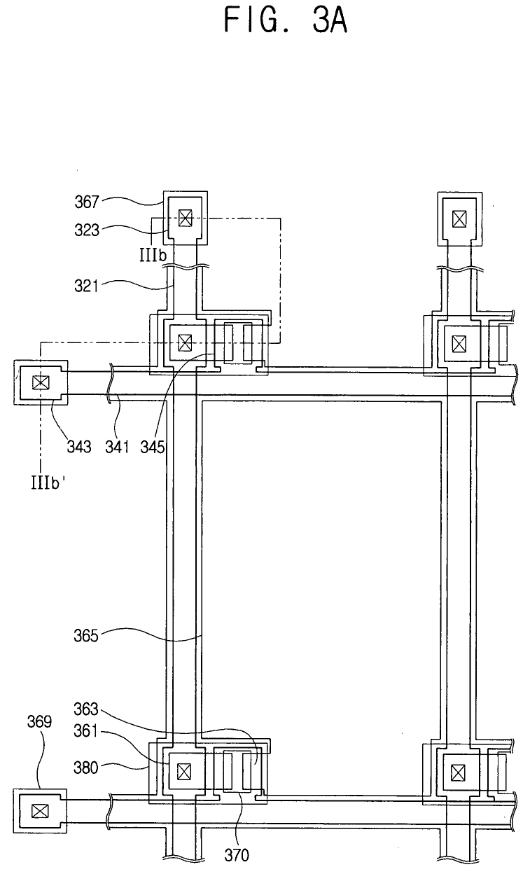

FIGS. 1A through 1G illustrate a patterning method according to the present invention, sequentially. FIGS. 2A through 2C illustrate a reaction when a surface active agent is exposed to light.

As shown in FIG. 1A, a surface active agent 110, which is photosensitive, is coated on a base film 100. Typically, the base film 100 may be a glass or plastic substrate, which is hydrophilic. The surface active agent 110 may comprise a tertriary-butoxy carbonyl group (tBOC group), which is hydrophobic, and a photo acid generator (PAG) as a reaction initiator. The PAG is photosensitive and generates an acid (H⁺) when exposed to light. The generated acid (H+) reacts with the tBOC group to change the nature of the surface active agent 110 from hydrophobic to hydrophilic. For example, the PAG may comprise naphoquinone diazide (NQD) The structural formula of the hydrophobic tBOC group is as follows.

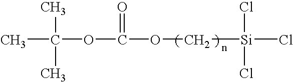

Here, n may be any value between 1 and 20.

Preferably, the surface active agent 110 comprises a material highly adhesive to an organic layer 120 (which is described below). As shown in FIG. 2A, a surface of the base film 100 is hydrophilic. When the base film 100 is coated with the hydrophobic surface active agent 110, they are combined as shown in FIG. 2B. “B” shown in FIG. 2B, refers to the tBOC group.

Then, the organic layer 120 is formed as shown in FIG. 1B. The organic layer 120 may be hydrophobic so that it is highly adhesive to the surface active agent 110. The organic layer 120 may be formed by a slit coating or spin coating.

As shown in FIG. 1C, a mask 10 which has a predetermined opening 12 is disposed above the organic layer 120. As shown therein, the mask 10 may be shaped like a plate having the predetermined opening 12. The opening 12 may correspond to a pattern of the organic layer 120 that is to be transferred to an insulating substrate 200 (FIG. 1E). Then, light is emitted through the mask 100, thereby exposing a part ‘a’ of the surface active agent 110 corresponding to the opening 12, as shown in FIG. 1D. Here, light may be any ultraviolet ray, visible ray or infrared ray. The mask 10 according to anther embodiment of the present invention may comprise a mask layer (not shown) which has a predetermined opening 12 and is formed on an organic layer 120. Here, the mask layer comprises a photosensitive material that blocks light. Preferably, the mask layer is removed after exposure.

As shown in FIG. 1D, the exposed part ‘a’ of the surface active agent 110 is changed from hydrophobic to hydrophilic by a reaction mechanism as follows.

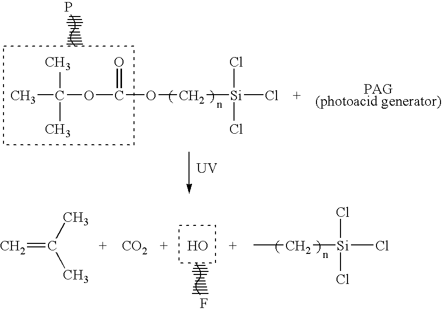

Here, “P” is a hydrophobic group, and “F” refers to a hydrophilic group.

As described in the reaction mechanism above, when light is emitted to the surface active agent 110, the PAG generates the acid (H⁺). The generated acid (H⁺) reacts with the tBOC group group, removing CH₂═C—(CH₃)₂ and CO₂ therefrom. Then, the surface active agent 110 having a hydrophilic group (HO) is formed on the base film 100 as shown in FIG. 2C. As the surface active agent 110 having the exposed part (a) is hydrophilic and the organic layer 120 is hydrophobic, the adhesiveness between the exposure part ‘a’ of the surface active agent 110 and the organic layer 120 is reduced.

As shown in FIG. 1E, the base film 100 is aligned to the insulating substrate 200 having a predetermined thin film 210, with the organic layer 120 facing thin film 210 Preferably, the base film 100 makes contact to the insulating substrate 200 to precisely transfer the exposed part ‘a’ to a predetermined position in the insulating substrate 200. Thus, additional aligning keys (not shown) may be provided on the base film 100 and the insulating substrate 200 respectively.

As shown in FIG. 1F, the inter-adhered base film 100 and the insulating substrate 200 are heated to increase the adhesiveness between the organic layer 120 and the insulating substrate 200. In one embodiment, the base film 100 and the insulating substrate 200 may be pressed against each other and heated at the same time.

As shown in FIG. 1G, when the base film 100 is separated from the insulating substrate 200, a part ‘b’ of the organic layer 120 corresponding to the exposed part ‘a’ of the surface active agent 110 is transferred to the insulating substrate 200. Next, the method of transferring the part ‘b’ of the organic layer 120 to the insulating substrate 200 is described. A repulsive force is generated between the exposure part ‘a’ of the surface active agent 110 and the surface of the organic layer 120 since the exposure part ‘a’ is hydrophilic and the organic layer 120 is hydrophobic. When the base film 100 is heated, while being pressed against the insulating substrate 200, the adhesion between the organic layer 120 and the insulating substrate 200 increases, while the repulsive force between the organic layer 120 and the surface active agent 110. Thus, when the base film 100 is separated from the insulating substrate 200, the part ‘b’ of the organic layer 120 is separated from the organic layer 120 and transferred to the insulating substrate 200. Thus, a pattern of the organic layer 120 is formed on the insulating substrate 200 without difficulty.

Hereinafter, a manufacturing method for a display device using the patterning method of the organic layer is described. A liquid crystal display (LCD) is described as an exemplary application of the present invention.

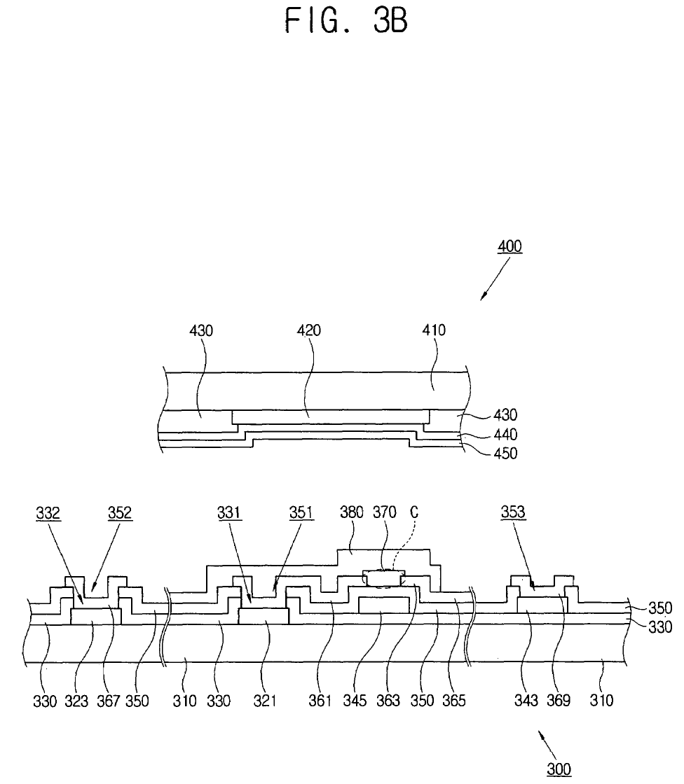

FIG. 3A illustrates a thin film transistor substrate according to the present invention. FIG. 3B is a sectional view of the thin film transistor substrate taken along line IIIb-IIIb′ in FIG. 3A.

The liquid crystal display (LCD) comprises a thin film transistor substrate 300 having a thin film transistor; a color filter substrate 400 having a color filter; and a liquid crystal layer interposed between the thin film transistor substrate 300 and the color filter substrate 400.

The thin film transistor substrate 300 comprises an insulating substrate 310; data wires 321 and 323 which are formed on the insulating substrate 310; an intermediate insulating film 330 which is formed on the data wires 321 and 323; gate wire 341, gate pad 343, gate electrode 345 which are formed on the intermediate insulating film 330; a gate insulating film 350 which is formed on the gate wire 341, gate pad 343 and gate electrode 345; transparent electrode features 361, 363, 365, 367 and 369 which are formed on the gate insulating film 350; and an organic semiconductor layer 370 which contacts with at least a part of the transparent electrode features 361, 363, 365, 367 and 369, and formed on the gate insulating film 350.

The insulating substrate 310 may comprise glass or plastic. When the insulating substrate 310 comprises plastic, the display device may be flexible, but the insulating substrate 310 is easily affected by heat. The insulating substrate 310 according to the present invention may comprise plastic, since the organic semiconductor layer 370 may be formed at a normal temperature and pressure. Here, the plastic may comprise polycarbonate, polyimide, polyethersulfone (PES), Polyarylate (PAR), polyethylene naphthalate (PEN) and polyethylene terephthalate (PET).

The data wires 321 and 323 are formed on the insulating substrate 310. The data wires 321 and 323 comprise a data line 321 which is formed on the insulating substrate 310; and a data pad 323 which is formed on an end part of the data line 321 and receives a driving or control signal from the outside. The data wires 321 and 323 may comprise at least one of Al, Cr, Mo, Au, Pt, Pd, ITO and IZO which are cost-effective and highly thermally conductive. The data wires 321 and 323 may comprise a single or a plurality of layers having at least one of the above-mentioned materials.

The intermediate insulating film 330 covers the data wires 321 and 323 on the insulating substrate 310. The intermediate insulating film 330 electrically insulating the above gate wire 341, gate pad 343, gate electrode 345 is formed on the data wires 321 and 323. The intermediate insulating film 330 may comprise an organic film such as benzocyclobutene (BCB), an acrylic photosensitive film, or a double layer having organic and inorganic films. When the intermediate insulating film 330 comprises the double layer, the inorganic film may comprise silicon nitride (SiNx) or silicon oxide (SiOx) with a thickness of hundreds of angstroms (Å), and the organic film prevents dirt from being introduced into the organic semiconductor layer 370. First contact holes 331 and 332 are formed on the intermediate insulating film 330 through which a part of the data wires 321 and 323 are exposed.

The gate wire 341, gate pad 343 and gate electrode 345 are formed on the intermediate insulating film 330. The gate wire 341, gate pad 343, gate electrode 345 comprise a gate line 341 which spatially cross the data line 321 and defines a pixel region; a gate pad 343 is provided on an end part of the gate line 341 and receives a driving or control signal from the outside; and a gate electrode 345 which is branched from the gate line 341 and corresponds to the organic semiconductor layer 370 (described later). The gate wire 341, gate pad 343 and gate electrode 345 may each comprise at least one of Al, Cr, Mo, Au, Pt and Pd, and may be provided as a single or a plurality of layers, like the data wires 321 and 323.

The gate insulating film 350 is formed on the gate wires 341, gate pad 343 and gate electrode 345. The gate insulating film 350 comprises a thick organic layer such as BCB to protect the organic semiconductor layer 370, which has weak chemical and plasma resistance, from dirt. The gate insulating film 350 according to another embodiment of the present invention may comprise a double-layer having organic and inorganic films. Here, the inorganic film may comprise silicon nitride (SiNx). The gate insulating film 350 comprises second contact holes 351 and 352 which correspond to the first contact holes 331 and 332 respectively; and a third contact hole 353 through which the gate pad 343 is exposed.

The transparent electrode features 361, 363, 365, 367 and 369 are formed on the gate insulating film 350. The transparent electrode features 361, 363, 365, 367 and 369 comprise a source electrode 361 which partially contacts with the organic semiconductor layer 370 through the first and second contact holes 331 and 351; a drain electrode 363 which is separated from the source electrode 361, with the organic semiconductor layer 370 interposed between the two electrodes; and a pixel electrode 365 which is connected with the drain electrode 363 and occupies a part of the pixel region. The transparent electrode features 361, 363, 365, 367 and 369 further comprise a data pad contact member 367 which is connected with the data pad 323 through the first and second contact holes 332 and 352; and a gate pad contact member 369 which is connected with the gate pad 343 through the third contact hole 353. The transparent electrode features 361, 363, 365, 367 and 369 comprise a transparent conductive material such as indium tin oxide (ITO) or indium zinc oxide (IZO). The source electrode 361 is connected with the data line 321 physically and electrically, through the second contact hole 351, to receive a video signal. The drain electrode 363 is separately spaced from the source electrode 361, with the gate electrode 345 interposed between the two electrodes, and defines a channel area (C). The drain electrode 363 forms the thin film transistor (TFT) together with the source electrode 361, and controls and drives the pixel electrode 365.

The organic semiconductor layer 370 is formed on the gate electrode 345 of the gate insulating film 350. The organic semiconductor layer 370 covers the channel area (C), and covers a part of the source electrode 361 and the drain electrode 363 which are exposed. The organic semiconductor layer 370 may be manufactured by an inkjet or evaporation method, or by the patterning method of the organic layer according to the present invention. The organic semiconductor layer 370 may comprise a derivative having a substituent such as tetracene or pentacene, or oligothiopenes of 4 or 8 connected through the positions 2 and 5 of thiopene ring. The organic semiconductor layer 370 may comprise perylene-tetracarboxylic-dianhydride (PTCDA) or an imide derivative thereof, or naphthalene-tetracarboxylic-dianhydride (NTCDA) or an imide derivative thereof. The organic semiconductor layer 370 may comprise metalized pthalocyanine or a halogenized derivative thereof, or perylene or coronene and a derivative having a substituent thereof. Preferably, copper, cobalt and zinc may be added to the metalized pthalocyanine. The organic semiconductor layer 370 may comprise a co-oligomer or co-polymer of thienylene and vinylene, or thienylene or coronene and a derivative comprising a substituent thereof, or a derivative comprising an aromatic or heteroaromatic ring having one or more hydrocarbon chains derivatives with carbon numbers between 1 and 30.

A passivation layer 380 is formed on the organic semiconductor layer 370. The passivation layer 380 protects the organic semiconductor layer 370 from deteriorating. The passivation layer 380 may comprise an organic film having polyvinyl alcohol (PVA) or BCB, or an acrylic photosensitive organic film. The passivation layer 380 covers from the first contact hole 351 to the channel area (C).

Hereinafter, the color filter substrate 400 is described. The color filter substrate 400 comprises an insulating substrate 410 which comprises an insulating material such as glass, quartz, ceramic or plastic; a black matrix 420 which is formed along a circumference of the insulating substrate 410; a color filter layer 430 which has three colors of red, green and blue, or magenta, cyan and yellow; an overcoat layer 440 which is formed on the color filter layer 430; and a common electrode 450 which is formed on the overcoat layer 440.

The black matrix 420 is shaped like a matrix or grid and formed on the insulating substrate 410. The black matrix 420 separates red, green and blue filters, and blocks light from directly getting through to a thin film transistor (T) disposed on the thin film transistor substrate 300. The black matrix 420 may comprise an organic material having a black pigment and may be manufactured by an exposure or development process, or by the patterning method of the organic layer according to the present invention. The black pigment may comprise carbon black or titanium oxide.

The color filter layer 430 may be formed of the repeated red, green and blue color filters or magenta, cyan and yellow color filters. The color filter layer 430 assigns color to light which passes through the liquid crystal layer (not shown). The color filter layer 430 may be provided by a known pigment dispersion method through coloring organic material, or by the patterning method of the organic layer according to the present invention.

The overcoat layer 440 protects the color filter layer 430, and may comprise acrylic epoxy.

The common electrode 450 comprises a transparent conductive material such as indium tin oxide (ITO) or indium zinc oxide (IZO). The common electrode 450 supplies a voltage to the liquid crystal layer (not shown), together with the pixel electrode 365 of the thin film transistor substrate 300.

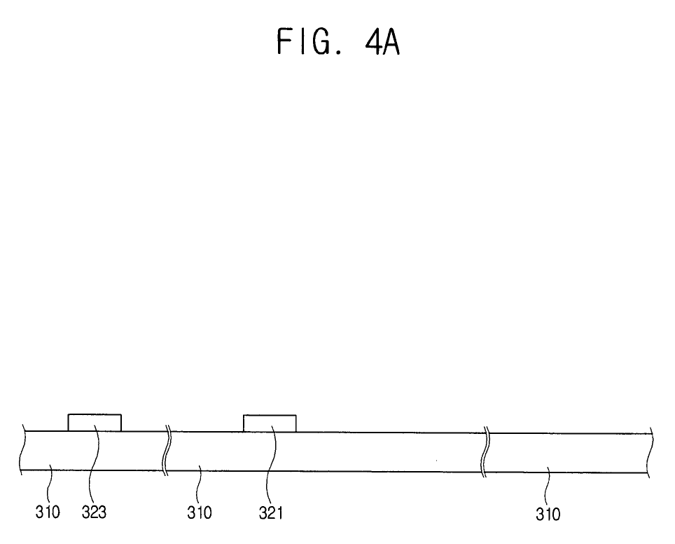

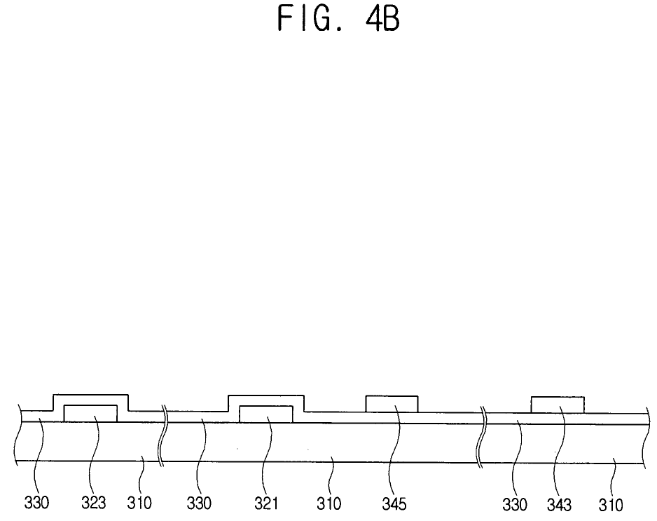

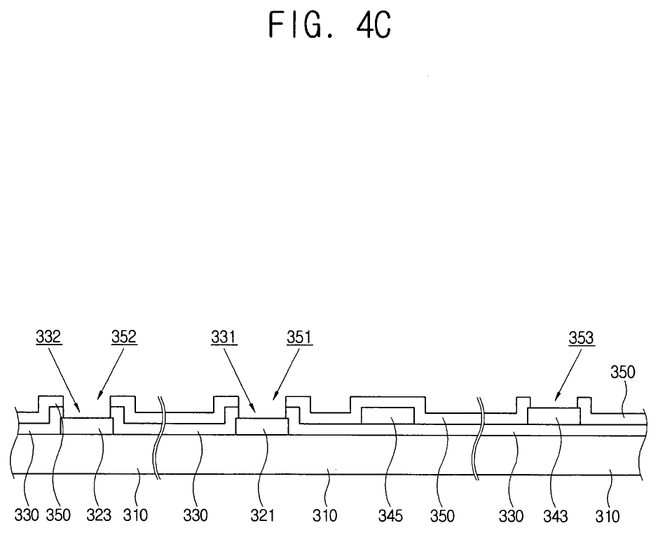

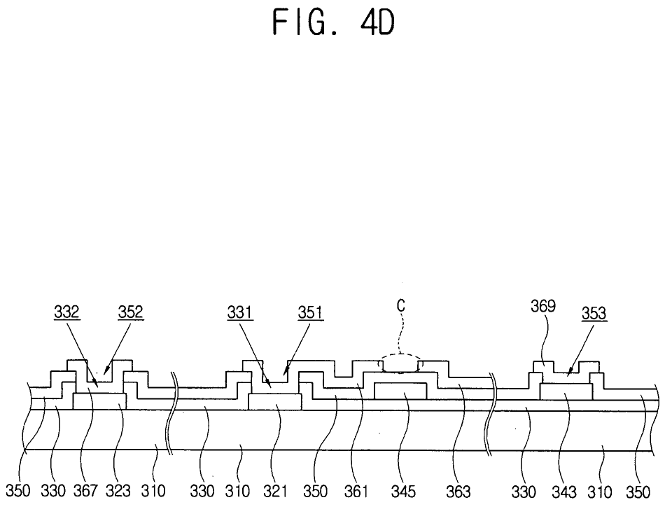

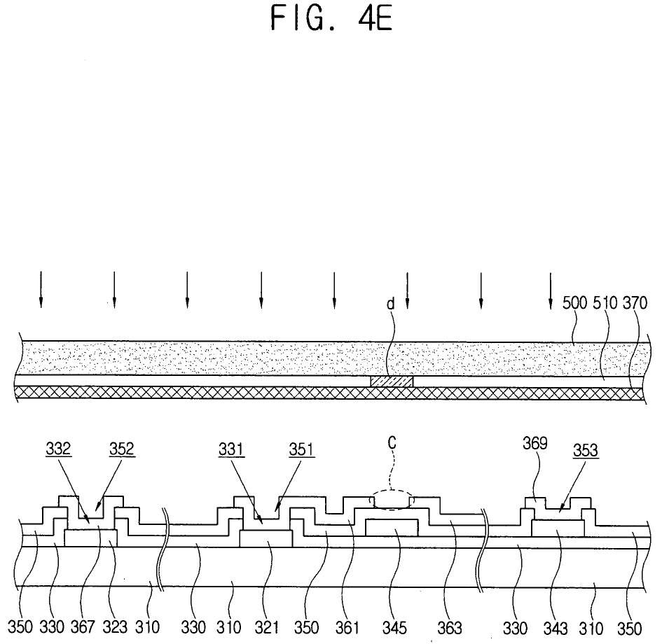

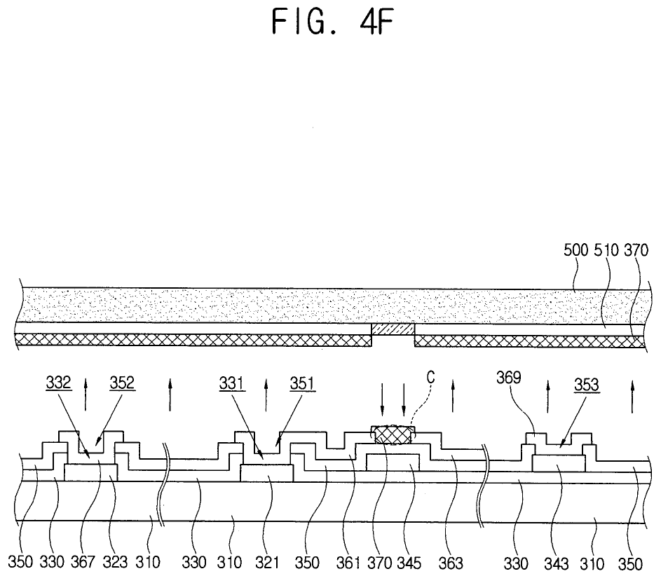

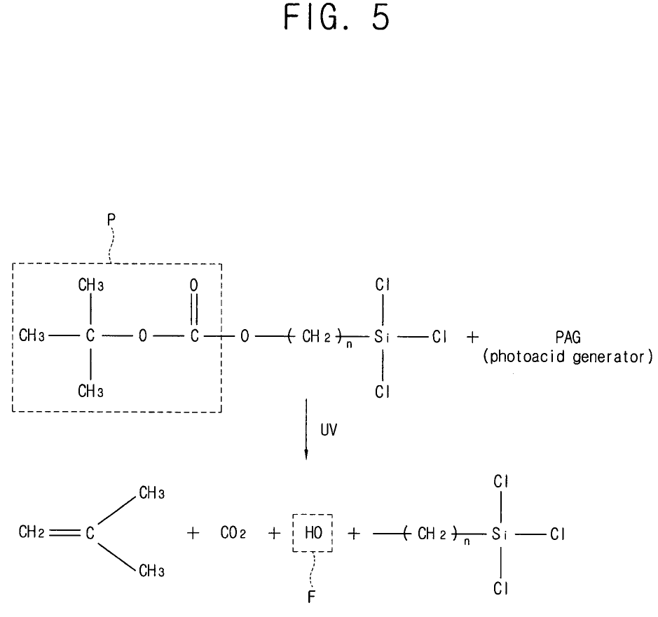

Referring to FIGS. 4A through 4F, a manufacturing method for the thin film transistor substrate 300 according to the present invention is described. Among various organic layers, the organic semiconductor layer 370 is described as an exemplary embodiment of the manufacturing method of the display device by using the patterning method of the organic layer according to the present invention. Alternatively, the organic layer may comprise a layer having a different organic material than the organic semiconductor layer 370.

As shown in FIG. 4A, the data wire 321 and data pad 323 are formed on the insulating substrate 310. The insulating substrate 310 may comprise an insulating material such as glass, quartz, ceramic or plastic. Preferably, the insulating substrate 310 comprises a plastic substrate when a flexible flat display device is manufactured. After depositing data wire material on the insulating substrate 310 through a sputtering method, the data wire 321 and the data pad 323 are formed on the insulating substrate 310 through photolithography.

As shown in FIG. 4B, the intermediate insulating film 330 is formed on the insulating substrate 310, and then the gate wires 341 (not shown in FIG. 4B, see FIG. 3A), gate pad 343 and gate electrode 345 are formed on the intermediate insulating film 330.

The intermediate insulating material having an inorganic material such as silicon nitride (SiNx) or silicon oxide (SiOx), and an organic material such as BCB are applied on the insulating substrate 310 and the data wires 321 and 323, to form the intermediate insulating film 330. When the intermediate insulating material comprises an organic material, the intermediate insulating film 330 may be formed through a spin coating or a slit coating. When the intermediate insulating material comprises an inorganic material, it may be formed by a chemical vapor deposition (CVD) or plasma enhanced chemical vapor deposition method. The intermediate insulating film 330 may comprise both an organic layer and an inorganic layer.

After a gate wire material having at least one of Al, Cr, Mo, Au, Pt and Pd is deposited on the intermediate insulating film 330 through a sputtering method, the gate wire 341, the gate pad 343 and the gate electrode 345 are formed on the intermediate insulating film 330 through photolithography.

As shown in FIG. 4C, the gate insulating film 350 which is a thick organic film that may include BCB is formed on the intermediate insulating film 330 and the gate wire 341, gate pad 343 and gate electrode 345. The gate insulating film 350 according to another embodiment of the present invention may comprise a double layer having an organic film and an inorganic film. Here, the inorganic film may comprise silicon nitride (SiNx). The gate insulating film 350 may be formed through a spin coating or slit coating. After forming the gate insulating film 350, a photosensitive film (not shown) is formed on the gate insulating film 350 as a predetermined pattern. Then, the first contact holes 331 and 332, the second contact holes 351 and 352 and the third contact hole 353 are simultaneously formed on the gate insulating film 350 through an etching method which uses the photosensitive film (not shown) as a blocking mask. Alternatively, the first contact holes 331 and 332, the second and third contact holes 351, 352 and 353 may be separately formed in each process.

As shown in FIG. 4D, after metal oxide which is transparent and conductive such as indium tin oxide (ITO) or indium zinc oxide (IZO) is formed on the gate insulating film 350 through a sputtering or evaporation method, the transparent electrode features 361, 363, 365, 367 and 369 are formed through photolithography or an etching method. The transparent electrode features 361, 363, 365, 367 and 369 comprise a source electrode 361 which partially contacts with the organic semiconductor layer 370 through the first and second contact holes 331 and 351; a drain electrode 363 which is separated from the source electrode 361, with the organic semiconductor layer 370 interposed between the two electrodes; and a pixel electrode 365 which is connected with the drain electrode 363 and a part of the pixel region. The transparent electrode features 361, 363, 365, 367 and 369 further comprise a data pad contact member 367 which is connected with the data pad 323 through the first and second contact holes 332 and 352; and a gate pad contact member 369 which is connected with the gate pad 343 through the third contact hole 353.

As shown in FIG. 4E, a base film 500 which has a surface active agent 510 and an organic semiconductor layer 370 is aligned on the transparent electrode features 361, 363, 365, 367 and 369. According to the patterning method of the organic layer, at least a part (d) of the surface active agent 510 corresponding to the organic semiconductor layer 370 to be transferred to the channel area (C) changes its nature from hydrophobic to hydrophilic by the exposure to light. As the exposure area (d) of the surface active agent 510 is hydrophilic and the organic semiconductor layer 370 is hydrophobic, the adhesion between the exposure area (d) of the surface active agent 510 and the organic semiconductor layer 370 decreases.

As shown in FIG. 4F, the base film 500 is adhered to the insulating substrate 310 so that the exposure area (d) corresponds to the channel area (C). When exposed to light, a mask having a predetermined opening is used. Each opening corresponds to the channel area (C). When the inter-adhered base film 500 and the insulating substrate 310, are heated, the adhesion between the organic semiconductor layer 370 and the insulating substrate 310 increases. When the base film 500 is separated from the insulating substrate 310, the organic semiconductor layer 370 corresponding to the exposure area (d) of the surface active agent 510 is transferred to the channel area (C). The method of transferring the organic semiconductor layer 370 to the channel area (C) is as follows. A repulsive force is generated between the exposure area (d) of the surface active agent 510 and the organic semiconductor layer 370 since the exposure area (d) is hydrophilic and the organic semiconductor layer 370 is hydrophobic. When the base film 500 is heated while being pressed to the insulating substrate 310 with the repulsive force acting between the exposure area (d) of the surface active agent 510 and the organic semiconductor layer 370, the adhesion of the organic semiconductor layer 370 with the gate insulating film 350, the source electrode 361 and the drain electrode 363 increases, thereby separating the part of the semiconductor organic layer 370 corresponding to the exposure area (d) of the surface active agent 510, from the organic semiconductor layer 370 and attaching it to the channel area (C). Thus, the pattern of the organic semiconductor layer 370 is formed on the channel area (C) without difficulty.

Then, a passivation film 380 is formed on the organic semiconductor layer 370. When the passivation layer 380 comprises a photosensitive organic film, the passivation film 380 may be patterned by sequential processes of coating, exposure and development methods. When the passivation film 380 comprises an inorganic film such as silicon nitride (SiNx), the passivation layer 380 may be patterned by a deposition and photolithography.

Accordingly, the thin film transistor substrate 300 having the organic thin film transistor (O-TFT) is manufactured.

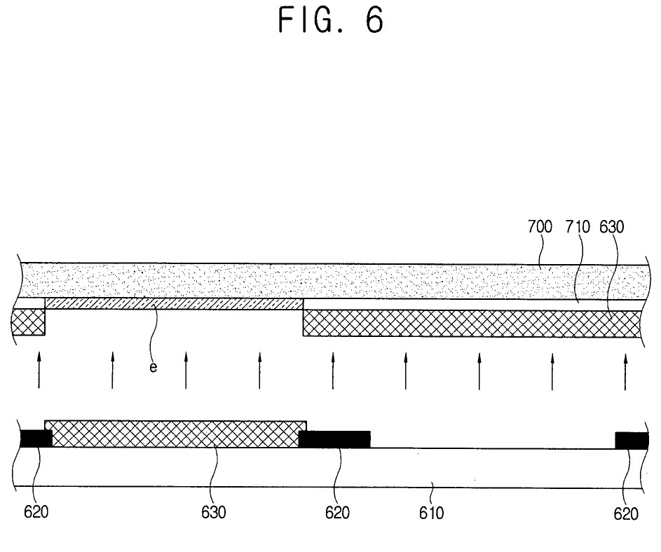

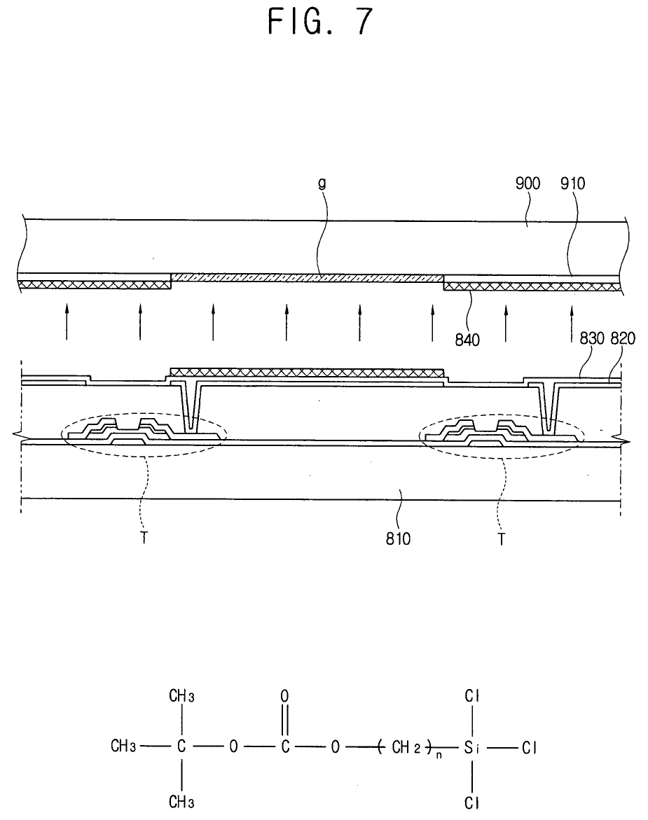

Referring to FIG. 6, a manufacturing method of the color filter substrate using the patterning method of the organic layer according to the present invention is described. Hereinafter, a method of forming the color filter layer 630 comprising organic material is described.

A black matrix 620 of a matrix or grid shape is formed on an insulating substrate 610. A base film 700 having a surface active agent 710 and a color filter layer 630 is disposed above the black matrix 620. The color filter layer 630 comprises one of red, green and blue colors. According to the patterning method of the organic layer, at least a part (e) of the surface active agent 710 corresponding to the color filter layer 630 to be transferred between each of the black matrixes 620 changes its nature from hydrophobic to hydrophilic. A mask having a predetermined opening is used to expose the black matrix 620 to light. The opening corresponds to the intermediate area between the black matrixes 620. As the exposure area (e) of the surface active agent 710 is hydrophilic, and the color filter layer 630 is hydrophobic, the adhesion between them decreases.

The base film 700 adheres to the insulating substrate 610 such that the exposure area (e) corresponds to the intermediate area between the black matrixes 620. The inter-adhered base film 700 and the insulating substrate 610, are heated, thereby increasing the adhesion between the color filter layer 630 and the insulating substrate 610. When the base film 700 is separated from the insulating substrate 610, the color filter layer 630 corresponding to the exposure area (e) of the surface active agent 710 is transferred to an intermediate area between the black matrixes 620. With the foregoing process, the color filter layer 630 having one of red, green and blue colors is formed. Also, the color filter layer 630 having another color is formed to complete the color filter layer 630 having all the three colors. Thus, the color filter layer 630 is formed on the intermediate area between the black matrixes 620 without difficulty.

The foregoing method can be applicable to forming the black matrix 620 having organic material on the insulating substrate 610 with a predetermined pattern.

Referring to FIG. 7, a manufacturing method for an organic light emitting diode (OLED) using the patterning method of the organic layer according to the present invention is described. Hereinafter, a method of forming an organic light emitting layer 840 having organic material is described.

An organic light emitting diode (OLED) emits light by applying an electrical signal to an organic material (organic light emitting layer). The OLED comprises a thin film transistor (T) formed on an insulating substrate 810; a pixel electrode 820 electrically connected with the thin film transistor (T); and a hole injection layer 830 formed on the pixel electrode 820. The hole injection layer 830 is uniformly applied to the pixel electrode 820. The hole injection layer 830 may comprise monomer and may be formed by a thermal deposition method. Alternatively, the hole injection layer 830 may be patterned to correspond to the pixel electrode 820.

To form an organic light emitting layer 840 with red, green and blue colors on the hole injection layer 830 to correspond to the pixel electrode 820, a base film 900 having a surface active agent 910 and an organic light emitting layer 840 is disposed on the hole injection layer 830. According to the patterning method of the organic layer, at least a part (g) of the surface active agent 910 corresponding to the organic light emitting layer 840 to be transferred to the pixel electrode 820 changes its nature from hydrophobic property to hydrophilic property by the exposure to light. When being exposed to light, a mask having a predetermined opening is used. The opening corresponds to the pixel electrode 820. As the exposure area (g) of the surface active agent 910 is hydrophilic, and the organic light emitting layer 840 is hydrophobic, the adhesion between the exposure area (g) of the surface active agent 910 and the organic light emitting layer 840 decreases.

The base film 900 is adhered to the insulating substrate 810 so that the exposure area (g) corresponds to the pixel electrode 820. When the inter-adhered base film 900 and the insulating substrate 810, are heated, the adhesion between the organic light emitting layer 840 and the hole injection layer 830 increases. When the base film 900 is separated from the insulating substrate 810, the organic light emitting layer 840 corresponding to the exposure area (g) of the surface active agent 910 is transferred to the hole injection layer 830. When the organic emitting layer 840 having one of red, green and blue colors is formed, the organic emitting layer 840 having another color is repeatedly formed to manufacture the OLED without difficulty.

In the conventional patterning method, a wall (not shown) defining the pixel electrode 820 is required to pattern the organic light emitting layer 840 corresponding to the pixel electrode 820. Thus, the organic light emitting layer 840 with red, green or blue color is patterned through an inkjet or thermal deposition method, to correspond to the pixel electrode 820.

According to the present invention, after the base film 900 having the organic light emitting layer 840 with one of red, green and blue color is exposed to light, it is adhered to the insulating substrate 810 having the pixel electrode 820 and the hole injection layer 830 and is heated, thereby patterning the organic light emitting layer 840 corresponding to the pixel electrode 820 on the hole injection layer 830 without difficulty. Since a process of forming a wall can be omitted, the overall process is simplified. If one of the organic light emitting layers is pattern in any color among red, green and blue, the organic emitting layer of other colors can be simply manufactured by repeating the above processes.

As described above, the present invention provides a patterning method of a simple manufacturing process, and a manufacturing method of a display device using the patterning method.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A patterning method, comprising:
coating a photosensitive surface active agent on a base film;
forming an organic layer on the surface active agent;
decreasing adhesiveness between the surface active agent and the organic layer by exposing the surface active agent to light through a mask having a predetermined opening on the organic layer;
adhering the base film to an insulating substrate, with the organic layer facing the insulating substrate; and
transferring the organic layer which corresponds to the exposed surface active agent to the insulating substrate by separating the base film from the insulating substrate.

2. The method according to claim 1, further comprising:
increasing adhesion between the organic layer and the insulating substrate by heating them after adhering the base film to the insulating substrate.

3. The method according to claim 2, wherein the surface active agent and the organic layer are hydrophobic, and the surface active agent is changed to hydrophilic by being exposed to light to decrease the adhesion between the surface active agent and the organic layer.

4. The method according to claim 3, wherein the opening corresponds to an area transferring to the insulating substrate of the organic layer.

5. The method according to claim 3, wherein the surface active agent comprises a tertiary-butoxy carbonyl group (tBOC group).

6. The method according to claim 5, wherein the surface active agent further comprises a photo acid generator (PAG).

7. The method according to claim 2, wherein the organic layer comprises an organic semiconductor layer, and the insulating substrate comprises a source electrode and a drain electrode which are separately spaced from each other and define a channel area, and the opening corresponds to the channel area.

8. The method according to claim 7, wherein the adhering the base film to the insulating substrate comprises adhering the base film to the insulating substrate so that the organic layer corresponding to the exposed surface active agent corresponds to the channel area.

9. The method according to claim 7, wherein the organic layer is transferred to the channel area to contact with a part of the source electrode and the drain electrode.

10. The method according to claim 9, wherein the insulating substrate further comprises:
a pixel electrode which partially contacts with the drain electrode, and wherein
the source electrode, the drain electrode and the pixel electrode are formed by the same mask.

11. The method according to claim 10, wherein the source electrode, the drain electrode and the pixel electrode comprise one of indium tin oxide (ITO) and indium zinc oxide (IZO).

12. The method according to claim 2, wherein a black matrix is provided on the insulating substrate, and the organic layer comprises a color filter layer, and
the organic layer is transferred to an intermediate area of the black matrix.

13. The method according to claim 12, wherein the opening corresponds to the intermediate area of the black matrix.

14. The method according to claim 2, wherein the organic layer comprises a black matrix.

15. The method according to claim 2, wherein a thin film transistor and a pixel electrode which is connected with the thin film transistor are provided on the insulating substrate, and the organic layer comprises an organic light emitting layer, and
the organic layer is transferred to the pixel electrode.

16. The method according to claim 15, wherein the opening corresponds to the pixel electrode.
